(19) United States
(12) Patent Application Publication
(10) Pub. No.: US 2024/0067540 A1
(43) Pub. Date: Feb. 29, 2024

(54) ELECTRODE FOR ELECTROCOAGULATION, METHOD TO OBTAIN THE ELECTRODE AND ELECTROCOAGULATION METHOD USING THE ELECTRODE

(71) Applicant: WET ARGENTINA S.A., Buenos Aires (AR)

(72) Inventors: Gustavo Luis BIANCHI, Province of Buenos Aires (AR); Carlos Javier SEIJAS, Province of Buenos Aires (AR); Juan Martín ALVAREZ, Province of Buenos Aires (AR)

(73) Assignee: WET ARGENTINA S.A., Buenos Aires (AR)

(21) Appl. No.: 17/822,977

(22) Filed: Aug. 29, 2022

(51) Int. Cl. C02F 1/461; C02F 1/463

(52) U.S. Cl. CPC C02F 1/46109; C02F 1/463; C02F 2001/46133

(57) ABSTRACT

An electrode for electrocoagulation, a method of obtaining it, and an electrocoagulation method using the electrode. Wherein, the electrode allows reducing energy consumption kWh/kg due to the fact that it has a reduced grain size obtained through a heat treatment that gives it the characteristic sought for the reduction in energy consumption.

### STATE OF THE ART OF THE INVENTION

### Field of Invention

The present invention relates to the field of devices, apparatus and arrangements used for the treatment of wastewater, more preferably to means or devices used in electrocoagulation, and more particularly the present invention relates to an electrode for electrocoagulation which significantly reduces kWh/kg energy consumption during said treatment, due to the novel development of the electrode with a grain size achieved by means of a method for obtaining it, also according to the invention, consisting of a heat treatment with its subsequent cooling method that give the electrode the ability to generate a concentration of ions in solution equal to or greater than conventional electrodes but with lower energy consumption that is reflected in lower operating costs of any water treatment plant, effluents and the like.

Even when in the present invention reference is made to an electrode made of aluminum and its alloys, it should be clear that the invention is not limited to said material, but other materials can still be considered and used to be treated with the method of the invention, by means of the corresponding adjustments according to each material, in order to obtain an electrode with a grain size capable of reducing the kW/h energy consumption during electrocoagulation.

### Description of Prior Art

In order to better understand the object and scope of the present invention, it is appropriate to describe the current state of the art with reference to wastewater treatments such as electrocoagulation. Electrocoagulation is an alternative method for wastewater treatment. As can be read on site https://blog.condorchem.com/electrocoagulation-aguas-residuales/, electrocoagulation consists of a process of destabilizing water pollutants whether they are in suspension, emulsified or dissolved, by the action of low voltage direct electric current and by the action of sacrificial metal electrodes, usually aluminum/iron.

It is a compact piece of equipment that operates continuously, through a specially designed reactor where the metal plates, cylinders or electrodes are located to produce electrocoagulation. In this process, a high load of cations is generated that destabilizes the pollutants in the wastewater, complex hydroxides are formed, these have adsorption capacity, producing aggregates (flocs) with the pollutants. On the other hand, due to the action of the gas formed, turbulence is generated and the produced flocs are pushed towards the surface.

Electrocoagulation allows the elimination of pollutants (oils and fats, heavy metals, colloids, organic molecules, color, etc.) in suspension, dissolved or emulsified from very diverse wastewater, coming from the electroplating, food, paper, leather, steel, textile industries, as well as laundries and plants for the production of water for human consumption, among others. After the electrocoagulation process, a waste is obtained in aqueous form composed of chemical species of iron linked to arsenic. This waste must be treated, using other conventional techniques, to separate as much water as possible and obtain a by-product with the smallest possible volume and easy to manage.

Electrocoagulation is a simple operation that requires relatively simple equipment, since the flocs formed by electrocoagulation contain little surface water, are acid-resistant and more stable, so they can be separated more easily by filtration. On the other hand, it is a low-cost technology that requires little investment in maintenance. In addition to being a technique for wastewater treatment, electrocoagulation also turns out to be a very interesting process to be applied, on the one hand, for the treatment of water before osmosis, but it can also be applied to reverse osmosis reject water. Reverse osmosis reject water can reach 60% of the treated volume. 80% of that 60% of reject could be recovered with electrocoagulation.

On the other hand, the effect of pH on electrocoagulation is reflected in the formation of the “floc” efficiency. It has been found that the performance of the process depends on the nature of the pollutant and the best removal has been observed for pH values close to 7. The oxide formed on the anode can, in many cases, form a layer that prevents the passage of electric current, thus reducing the efficiency of the process, although this could be avoided with a high conductivity of water to be treated. By decreasing the efficiency of the process, current intensity is increased and consequently, in an energy consumption that, depending on the place, its monetary cost may be high, being unfeasible.

Under the current state of the art available for the treatment of wastewater by electrocoagulation, it would be very appropriate to have a new arrangement, device or means being constituted and built to carry out said treatment in order to reduce kWh/kg energy consumption with the aim of optimizing the electrocoagulation process.

### BRIEF DESCRIPTION OF THE INVENTION

It is therefore an object of the present invention to provide a new electrode for electrocoagulation that reduces kWh/kg energy consumption of material generated, in order to optimize wastewater sanitation processes.

It is still another object of the present invention to provide an electrode that provides the same concentration of ions in solution with lower energy consumption.

It is also another object of the present invention to provide an electrode that is easily corrodible and that has a reduced grain size compared to conventional electrodes, and that by virtue of this, allows energy consumption to be reduced.

It is yet another object of the present invention to provide a method for obtaining said electrode, in order to subject it to a heat treatment to obtain the desired grain size that allows reducing energy consumption.

It is also an object of the present invention to provide an electrode for electrocoagulation, intended to be used in wastewater electrocoagulation plants, comprising an electrode piece made of material selected from the group consisting of Aluminum, its alloys, Iron, and its alloys, said electrode piece being subjected to heat treatment by heating said electrode piece for a period of time between 1 and 5 hours, at a temperature between 400° C. and 900° C., and subsequent cooling of the electrode piece, the material of said electrode piece having a grain size measured by optical microscopy between 0.087 mm and 1.520 mm.

### BRIEF DESCRIPTION OF THE DRAWINGS

For greater clarity and understanding of the object of the present invention, it has been illustrated in several figures, in which the invention has been represented in a preferred embodiment, all by way of example, wherein:

FIG. 1 shows an Al—Mg phase diagram used as a reference to carry out the heat treatment of Al 5086 H32;

FIG. 2 shows an Al—Si phase diagram used as a reference to carry out the heat treatment of Al 1050;

FIGS. 3 and 4 show Al—Cu phase diagrams used as a reference to carry out the heat treatment of Al 2005 T3;

FIG. 5 shows the Al—Cu phase diagram where different temperature ranges or zones can be observed to carry out the heat treatment of the alloys;

FIG. 6 shows a comparative graph of the variation in kWh/kg energy consumption depending on the adjustment of the pH of the medium and the type of treatment to which the 5086 H32 aluminum electrode has been subjected;

FIG. 7 shows a grain size micrograph of Al 5086 H32 without treatment;

FIG. 8 shows a grain size micrograph of Al 5086 H32 subjected to heat treatment and cooled in water;

FIG. 9 shows a grain size micrograph of Al 5086 H32 subjected to heat treatment and cooled in air;

FIG. 10 shows a grain size micrograph of Al 5086 H32 subjected to heat treatment and cooled in furnace;

FIG. 11 shows a comparative graph of the variation in kWh/kg energy consumption as a function of the adjustment of the pH of the medium and the type of treatment to which the aluminum electrode 1050 has been subjected;

FIG. 12 shows a grain size micrograph of Al 1050 without treatment;

FIG. 13 shows a grain size micrograph of Al 1050 subjected to heat treatment and cooled in water;

FIG. 14 shows a grain size micrograph of Al 1050 subjected to heat treatment and cooled in air;

FIG. 15 shows a grain size micrograph of Al 1050 subjected to heat treatment and cooled in furnace;

FIG. 16 shows a comparative graph of the variation in kWh/kg energy consumption depending on the adjustment of the pH of the medium and the type of treatment to which the 2005 T3 aluminum electrode has been subjected;

FIG. 17 shows a grain size micrograph of Al 2005 T3 without treatment;

FIG. 18 shows a grain size micrograph of Al 2005 T3 subjected to heat treatment and cooled in water;

FIG. 19 shows a grain size micrograph of Al 2005 T3 subjected to heat treatment and cooled in air; and

FIG. 20 shows a grain size micrograph of Al 2005 T3 subjected to heat treatment and cooled in furnace.

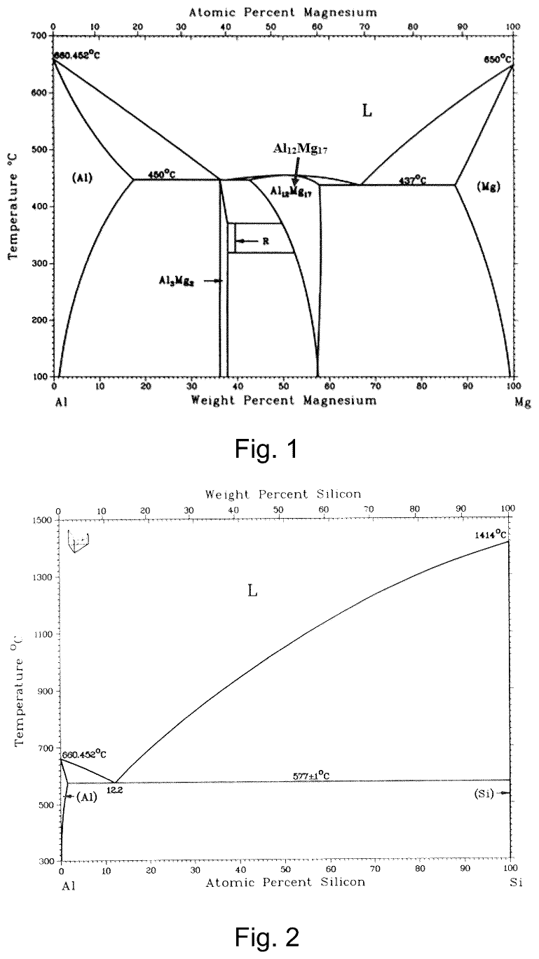

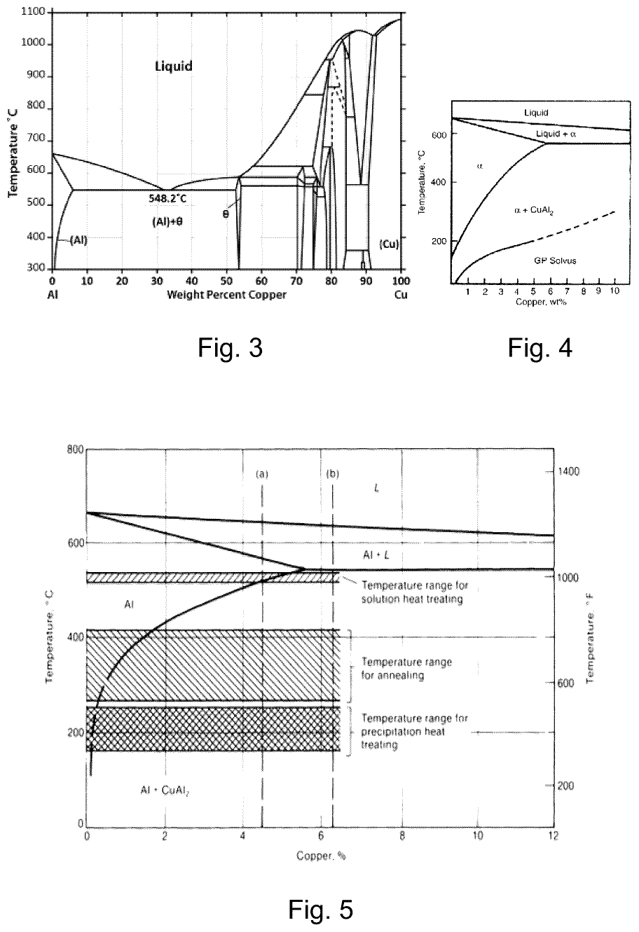

### DETAILED DESCRIPTION OF THE INVENTION

Referring now to the figures, it can be seen that the invention consists of a new electrode for electrocoagulation intended to be used in wastewater electrocoagulation plants, which allows reducing kWh/kg energy consumption due to its reduced grain size obtained by virtue of the heat treatment to which it is subjected.

Thus, the electrode of the invention comprises an electrode of material selected from the group consisting of Aluminum, its alloys, Iron, and its alloys, said electrode piece being subjected to heat treatment by heating said electrode piece for a period of time between 1 and 5 hours, at a temperature between 400° C. and 900° C., and the subsequent cooling of the electrode piece selected between air, water or furnace cooling. In this way, it is achieved that the material of said electrode piece presents a high susceptibility to corrosion with a grain size measured by optical microscopy between 0.087 mm and 0.530 mm capable of reducing kWh/kg energy consumption and providing the same or higher concentration of ions in solution than conventional electrodes. It is noted that untreated aluminum alloy electrodes generally have a grain size between 0.169 mm and 1.520 mm.

According to the present invention, by way of example but not limiting the same, said material of the electrode piece is selected from the group of alloys consisting of Aluminum 1050, Aluminum 5086 H32 and Aluminum 2005 T3. More preferably for the invention, said electrode that allows a greater reduction in energy consumption, but is not limited, comprises an aluminum alloy 5086 H32 whose grain size is 0.087 mm. The reduction of the grain size in the mentioned electrode shall imply a reduction of energy consumption with a production of ion concentration in solution equal to or greater than conventional methods, being that said reduction of grain size is achieved by virtue of the heat treatment provided by means of the present invention.

For this purpose, an electrode piece must first be provided with a material selected from the group consisting of Aluminum, its alloys, Iron, and its alloys. Then, heat the electrode piece for a period of time between 1 and 5 hours, at a temperature between 400° C. and 900° C. Finally, cool the electrode piece by means of at least one of the following cooling modes: Water cooling; intermediate air cooling, and slow cooling by leaving the electrode inside the turned-off furnace until it reaches room temperature.

For practical purposes, it has been decided to use a electrode piece of aluminum which is selected from the group of alloys consisting of Aluminum 1050, Aluminum 5086 H32 and Aluminum 2005 T3, more particularly for the invention but not being limiting, it has been obtained a grain size of 0.087 mm by means of the following combination: electrode of alloy Aluminum 5086 H32, heating period of 1 hour at heating temperature of 550° C. and intermediate air cooling. By means of said Al 5086 H32 electrode subjected to heat treatment as mentioned above, the greatest reduction in kWh/kg energy consumption has been achieved.

In an example of application of the electrode obtained by means of the invention, but not being limiting, an electrocoagulation method takes place in an electrocoagulation plant that includes a mass of wastewater to be purified and sacrificial electrodes in said mass of water, and wherein electric current is circulated through said mass of water and the electrodes to produce the destabilization of the pollutants in the water that are in suspension, in emulsion or in solution, wherein said method comprises the step of adjusting the pH of said mass of wastewater to a value between 6 and 10.

More preferably, but not being limiting, it has been found that the optimal results for the generation of a higher concentration of ions in solution with the lowest kWh/kg energy consumption of aluminum, is given by using the aluminum alloy 5086 H32 electrode subjected to heat treatment and cooled in air, with a grain size of 0.087 mm and a pH adjustment of 7. With this combination, an energy consumption of 35.14 kWh/kg has been achieved compared to an energy consumption of 44.67 kWh/kg of an electrode of the same Al 5086 H32 alloy without treatment, and under the same pH 7. As can be seen, there is a notable and important reduction in energy consumption achieved by means of the heat treatment (described above) to which the Al 5086 H32 alloy electrode was subjected according to the invention. When the Al 5086 H32 electrode was subjected to the heat treatment of the invention, it was possible to reduce the grain size and consequently significantly reduce energy consumption.

Although it has been mentioned that the optimal combination for electrocoagulation with the lowest possible energy consumption occurs with the 5086 H32 aluminum alloy electrode being subjected to heat treatment, cooled in air and in a medium with pH 7, this does not imply that the invention is limited to it, but other materials can be considered and used without any inconvenience. Any other material or alloy can be subjected to heat treatment through the method of the invention and in accordance with its corresponding phase diagram, in order to obtain a reduced grain size, with the consequent test to determine if it achieves a reduction in energy consumption.

In this way, the invention manages to reduce the kWh/kg energy consumption by virtue of the reduced grain size obtained by means of the heat treatment to which it was subjected. Although, in the field of art, the fact that when using heat treatments the grain size is varied, there is no study, trial or technical approach that a suitable grain size can reduce the energy consumption as proposed in the present invention.

Influence of grain size on corrosion can be found in the literature. Wherein, when the grain size is small, there is more grain boundary, more entropy and more corrosion. Greater anodic dissolution of the material in an aqueous medium, ergo more electrons circulating since corrosion in an aqueous medium is like a galvanic cell. The lower the entropy, the larger the grains, less grain boundary exposed to the medium, corrosion is less and consequently there are fewer electrons going around.

However, again as of the date of this patent application, no studies, tests or bibliography have been found where the energy consumption during electrocoagulation is related to the grain size of the electrode used, this being of great importance due to the related monetary costs involved.

In the following Examples, the foregoing shall be extended by means of data obtained according to the treatments and tests carried out.

### Example 1

1) 5086 H32 Aluminum Alloy Electrode

There are four Al 5086 H32 electrodes which comprise:
a) Al 5086 H32 Electrode not subjected to heat treatment;
b) Al 5086 H32 Electrode subjected to heat treatment, cooled in water;
c) Al 5086 H32 Electrode subjected to heat treatment, cooled in air; and
d) Al 5086 H32 Electrode subjected to heat treatment, cooled in the furnace.

In cases b) to d), and particularly using the phase diagram of FIG. 5, each of the electrodes b) to d) was heated in a furnace for one hour at a temperature of 550° C. As mentioned above, the object of the present invention is to reduce the kWh/kg energy consumption in the electrocoagulation operating stage based on the grain size obtained and not being relevant the mechanical properties of the material. This is due to the fact that during electrocoagulation the electrode will be fixed in the reactor and is not subjected to stress, impact or deformation. Thus, the temperatures at which the heat treatment “heat treatment of the solution” can be carried out according to FIG. 5 were taken as reference.

After heating, the electrode was cooled, in case b) by rapid cooling in a large volume of water. In case c), cooling was carried out by intermediate air cooling, and in case d), a slow cooling was carried out, leaving the electrode inside the turned-off furnace until it reached room temperature.

Once the heat treatments of the electrodes b) to d) were completed, their final microstructure was analyzed by optical microscopy in order to verify microstructural changes, more particularly to verify changes in grain size. Before that, a representative sample was prepared in all cases as follows:
Representative 1 cm2 samples were cut from each electrode and embedded in phenolic resin.
Roughing and sanding was done with water sandpaper with 100, 150, 220, 360, 600 and 1000 granulometry. Finally, the polishing was done with 1 μm and 6 μm alumina cloth.
Chemical etching for surface development was carried out using Weck's experimental reagent (Weck's Reagent). 5% NaOH and KMnO₄ solution. Etching times varied, depending on the type of aluminum alloy, but immersions were made in the solution at room temperature in stages of 20 seconds, reaching a maximum of 60 seconds of contact between the metal and the reagent.
Then it was washed with tap water at room temperature, rinsed with distilled water followed by ethyl alcohol and finally dried with a stream of hot air.

It is emphasized that the steps mentioned above for the preparation of the electrode samples before carrying out the metallographic analysis shall be the same for the other examples that are mentioned below. However, said steps are not limiting for the invention since other sample preparation methods can be considered and used without any inconvenience.

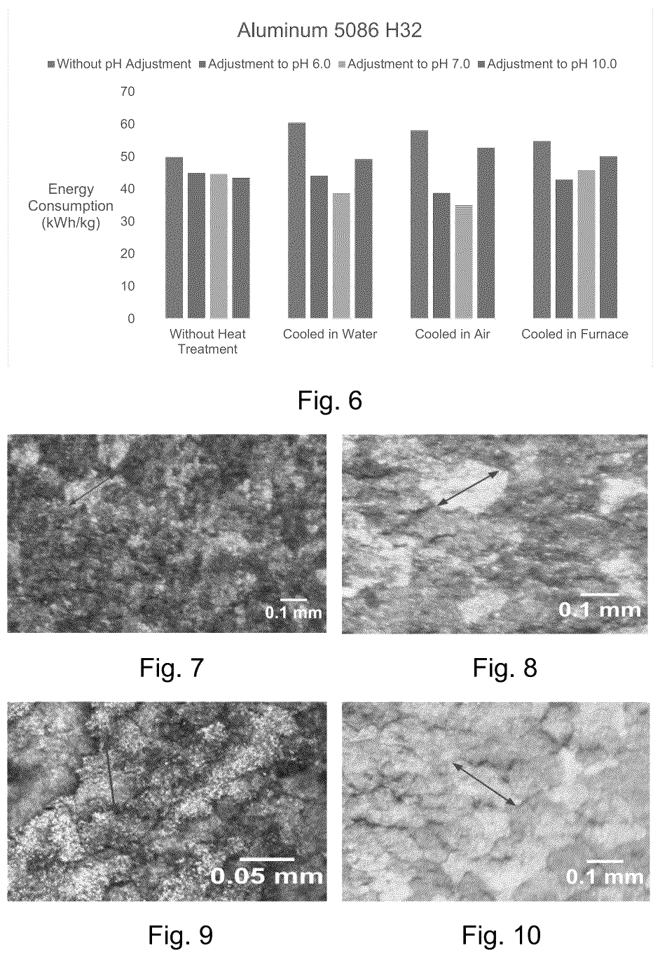

According to FIGS. 7 to 10, the grain size according to each electrode is indicated by arrows. Thus, FIG. 7 shows the metallography of the electrode a) Al 5086 H32 not subjected to heat treatment. FIG. 8 corresponds to electrode b) Al 5086 H32 subjected to heat treatment and cooled in water. FIG. 9 with electrode c) Al 5086 H32 subjected to heat treatment and cooled in air. And, FIG. 10 corresponds to electrode d) Al 5086 H32 subjected to heat treatment and cooled in a furnace. According to the micrographs in FIGS. 7 to 10, the following grain sizes were obtained for each electrode:

| | a) Not subjected to | b) Cooled | c) Cooled | d) Cooled |
|---|---|---|---|---|
| Al 5086 H32 | heat treatment | in water | in air | in furnace |
| Grain | 0.169 | 0.188 | 0.087 | 0.171 |
| size (mm) | | | | |

After analyzing the grain size by optical microscopy, each electrode a) to d) was tested in an electrocoagulation process to determine their energy consumption kWh/kg and perform a comparative analysis of energy consumption based on grain size. In turn, and as mentioned above, the pH of the medium was adjusted in a range from 6 to 10 in order to expand and obtain a better analysis. To carry out the electrode tests, the following physicochemical parameters of the reverse osmosis reject water were used:

| Source | Reverse Osmosis Reject Water |
|---|---|
| pH | 8.19 |
| Conductivity (μS/cm) | 975 |
| Alkalinity (mg/L CaCO₃) | 576 |
| Hardness (mg/L CaCO₃) | 150 |
| Silica (mg/L) | 42.4 |
| Chlorides (mg/L) | 96.6 |
| Sulfates (mg/L) | 79 |
| Ca⁺² (mg/L) | 28 |
| Mg⁺² (mg/L) | 15.8 |
| Turbidity (NTU) | 0.63 |

After carrying out the tests of the electrodes a) to d) with a pH of 8, the corresponding adjustments of pH 6, 7 and 10 with their respective tests were made. It is emphasized, but not limiting the invention, that the adjustment to acidic values is carried out with 1M HCl, and to basic values with 1M NaOH. While operating conditions, that did not vary, were: 150 mL of sample, 0.25 Ampere of constant current, process time 10 minutes, mechanical stirring by magnetic stir bar and separation between electrodes of 15 mm.

Thus, according to FIG. 6, a comparative graph was obtained of the variation in energy consumption kWh/kg depending on the adjustment of the pH of the medium and the type of treatment to which the 5086 H32 aluminum electrodes have been subjected. According to the graph in FIG. 6, it was obtained that:

| | a) Not | | | |
|---|---|---|---|---|
| | subjected to | b) Cooled | c) Cooled | d) Cooled |
| Al 5086 H32 | heat treatment | in water | in air | in furnace |
| Without adjustment | 49.73 | 60.45 | 58.07 | 54.79 |
| (pH = 8.2) | | | | |
| Adjustment to | 44.96 | 44.07 | 38.71 | 42.88 |
| pH = 6 | | | | |
| Adjustment to e | 44.67 | 38.71 | 35.14 | 45.86 |
| pH = 7 | | | | |
| Adjustment to | 43.48 | 49.13 | 52.71 | 50.03 |
| pH = 10 | | | | |

Based on the data obtained, it is concluded that using the aluminum electrode without treatment, by lowering the pH from 8 to 7, the consumption goes from 49.73 kWh/kg Al generated to 44.67 kWh/kg Al generated. This 10% energy saving is due to the presence of chlorides as a result of the contribution of HCl when adjusting the pH. Chlorides favor the dissolution of aluminum avoiding the passivation of the alloy in the process. When, together with the pH adjustment to 7, the heat treated and air-cooled electrode was used, this consumption dropped to 35.14 kWh/kg Al generated (30% energy savings). In this condition, the material has the smallest grain size of all those analyzed, 0.087 mm. However, at pH 10, as these chlorides are not present, the grain size does not affect the electrical consumption in the electrochemical treatment. Likewise, reductions in consumption can be observed for a pH of 6, the reduction being notable for electrode c).

### Example 2

1) 1050 Aluminum Alloy Electrode

There are four Al 1050 electrodes which comprise:
e) Al 1050 Electrode not subjected to heat treatment;
f) Al 1050 Electrode subjected to heat treatment, cooled in water;
g) Al 1050 Electrode subjected to heat treatment, cooled in air; and
h) Al 1050 Electrode subjected to heat treatment, cooled in the furnace.

In cases f) to h), and particularly using the phase diagram of FIG. 5, each of the electrodes f) to h) was heated in a furnace for one hour at a temperature of 550° C. as in Example 1. As mentioned above, the object of the present invention is to reduce the kWh/kg energy consumption in the electrocoagulation operating stage based on the grain size obtained and not being relevant the mechanical properties of the material. This is due to the fact that during electrocoagulation the electrode shall be fixed in the reactor and is not subjected to stress, impact or deformation. Thus, the temperatures at which the heat treatment “solution heat treatment” can be carried out were taken as a reference, according to FIG. 5.

After heating, the electrode was cooled, in case f) by rapid cooling in a large volume of water. In case g), cooling was carried out by intermediate cooling in air, and in case h), slow cooling was carried out, leaving the electrode inside the turned-off furnace until it reached room temperature.

Once the heat treatments of the electrodes f) to h) were completed, their final microstructure was analyzed by optical microscopy in order to verify microstructural changes, more particularly to verify changes in grain size. Before that, the preparation of a representative sample was carried out in all cases as mentioned for Example 1.

According to FIGS. 12 to 15, the grain size according to each electrode is indicated by arrows. Thus, FIG. 12 shows the metallography of the electrode e) Al 1050 not subjected to heat treatment. FIG. 13 corresponds to the electrode f) Al 1050 subjected to heat treatment and cooled in water. FIG. 14 with electrode g) Al 1050 subjected to heat treatment and cooled in air. And, FIG. 15 corresponds to the electrode h) Al 1050 subjected to heat treatment and cooled in a furnace. According to the micrographs in FIGS. 12 to 15, the following grain sizes were obtained for each electrode:

| | e) Not subjected to | f) Cooled | g) Cooled | h) Cooled |
|---|---|---|---|---|
| Al 1050 | heat treatment | in water | in air | in furnace |
| Grain | 1.520 | 0.489 | 0.428 | 0.530 |
| size (mm) | | | | |

After analyzing the grain size by optical microscopy, each electrode e) to h) was tested in an electrocoagulation process to determine their kWh/kg energy consumption and perform a comparative analysis of energy consumption based on grain size. In turn, and as mentioned above, the pH of the medium was adjusted in a range from 6 to 10 in order to expand and obtain a better analysis. To carry out the electrode tests, the following physicochemical parameters of the reverse osmosis reject water were used:

| Source | Reverse Osmosis Reject Water |
|---|---|
| pH | 8.19 |
| Conductivity (μS/cm) | 975 |
| Alkalinity (mg/L CaCO₃) | 576 |
| Hardness (mg/L CaCO₃) | 150 |
| Silica (mg/L) | 42.4 |
| Chlorides (mg/L) | 96.6 |
| Sulfates (mg/L) | 79 |
| Ca⁺² (mg/L) | 28 |
| Mg⁺² (mg/L) | 15.8 |
| Turbidity (NTU) | 0.63 |

After carrying out the tests of the electrodes e) to h) with a pH of 8, the corresponding adjustments of pH 6, 7 and 10 with their respective tests were made. It is emphasized, but not limiting the invention, that the adjustment to acidic values is carried out with 1M HCl, and to basic values with 1M NaOH. While operating conditions, that did not vary, were: 150 mL of sample, 0.25 Ampere of constant current, process time 10 minutes, mechanical stirring by magnetic stir bar and separation between electrodes of 15 mm.

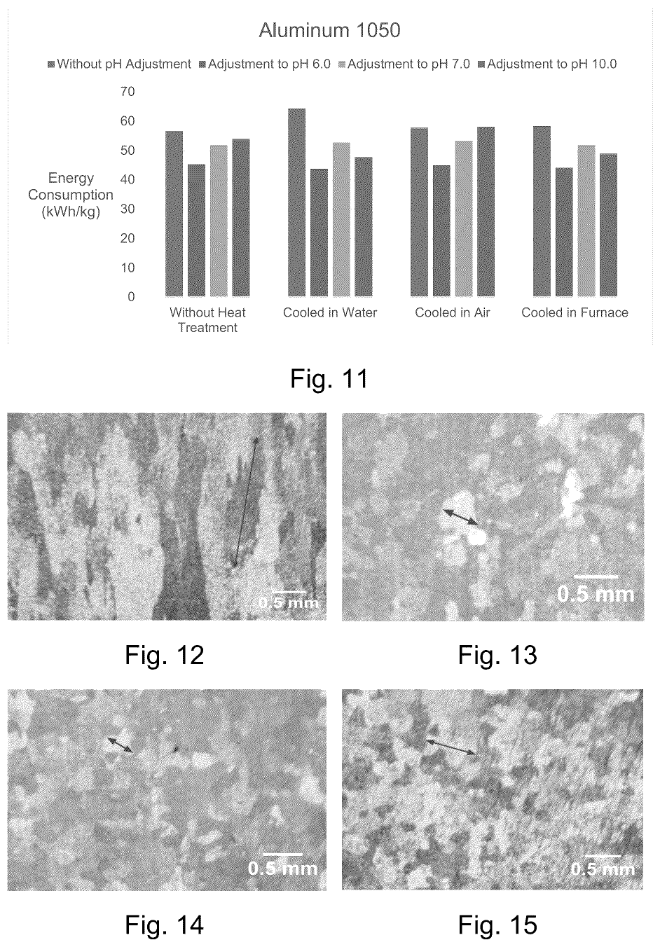

Thus, according to FIG. 11, a comparative graph was obtained of the variation in kWh/kg energy consumption depending on the adjustment of the pH of the medium and the type of treatment to which the 1050 aluminum electrodes have been subjected. According to the graph from FIG. 11, it was obtained that:

| | e) Not | | | |
|---|---|---|---|---|
| | subjected to | f) Cooled | g) Cooled | h) Cooled |
| Al 1050 | heat treatment | in water | in air | in furnace |
| Without adjustment | 56.58 | 64.32 | 57.77 | 58.36 |
| (pH = 8.2) | | | | |
| Adjustment to | 45.26 | 43.77 | 44.96 | 44.07 |
| pH = 6 | | | | |
| Adjustment to | 51.81 | 52.71 | 53.30 | 51.81 |
| pH = 7 | | | | |
| Adjustment to | 53.90 | 47.64 | 58.07 | 48.84 |
| pH = 10 | | | | |

Based on the data obtained, it is concluded that with the Al 1050 aluminum alloy electrode, slight reductions in energy consumption kWh/kg were obtained, particularly for the adjustment of the pH to 6. Contrary to Example 1, a reduction in grain size generated a reduction in energy consumption for electrodes f) and h) with a pH of 10.

### Example 3

1) 2005 T3 Aluminum Alloy Electrode

There are four Al 2005 T3 electrodes which comprise:
i) Al 2005 T3 Electrode not subjected to heat treatment;
j) Al 2005 T3 Electrode subjected to heat treatment, cooled in water;
k) Al 2005 T3 Electrode subjected to heat treatment, cooled in air; and
l) Al 2005 T3 Electrode subjected to heat treatment, cooled in the furnace.

In cases j) to l), and particularly using the phase diagram of FIG. 5, each of the electrodes j) to l) was heated in a furnace for one hour at a temperature of 550° C. as in the Example 1. As mentioned above, the object of the present invention is to reduce the kWh/kg energy consumption in the electrocoagulation operating stage based on the grain size obtained and not being relevant the mechanical properties of the material. This is due to the fact that during electrocoagulation the electrode shall be fixed in the reactor and is not subjected to stress, impact or deformation. Thus, the temperatures at which the heat treatment “solution heat treatment” can be carried out were taken as a reference, according to FIG. 5.

After heating, the electrode was cooled, in case j) by rapid cooling in a large volume of water. In case k), cooling was carried out by intermediate air cooling, and in case l), a slow cooling was carried out, leaving the electrode inside the turned-off furnace until it reached room temperature.

Once heat treatments to electrodes j) to l) were completed, their final microstructure was analyzed by optical microscopy in order to verify microstructural changes, more particularly to verify changes in grain size. Before that, the preparation of a representative sample was carried out in all cases as mentioned for Example 1.

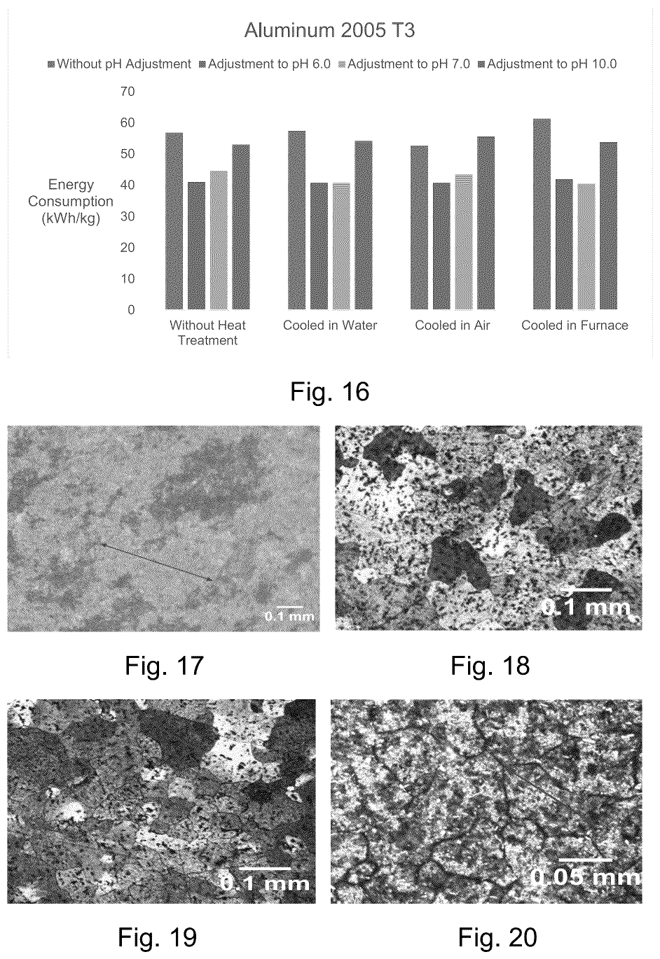

According to FIGS. 17 to 20, the grain size according to each electrode is indicated by arrows. Thus, FIG. 17 shows the metallography of the electrode i) Al 2005 T3 not subjected to heat treatment. FIG. 18 corresponds to electrode j) Al 2005 T3 subjected to heat treatment and cooled in water. FIG. 19 with electrode k) Al 2005 T3 subjected to heat treatment and cooled in air. And, FIG. 20 corresponds to the electrode l) Al 2005 T3 subjected to heat treatment and cooled in a furnace. According to the micrographs in FIGS. 17 to 20, the following grain sizes were obtained for each electrode:

| | i) Not subjected to | j) Cooled | k) Cooled | l) Cooled |
|---|---|---|---|---|
| Al 2005 T3 | heat treatment | in water | in air | in furnace |
| Grain | 0.441 | 0.116 | 0.134 | 0.118 |
| size (mm) | | | | |

After analyzing the grain size by optical microscopy, each electrode i) to l) was tested in an electrocoagulation process to determine their kWh/kg energy consumption and perform a comparative analysis of energy consumption based on grain size. In turn, and as mentioned above, the pH of the medium was adjusted in a range from 6 to 10 in order to expand and obtain a better analysis. To carry out the electrode tests, the following physicochemical parameters of the reverse osmosis reject water were used:

| Source | Reverse Osmosis Reject Water |
|---|---|
| pH | 8.19 |
| Conductivity (μS/cm) | 975 |
| Alkalinity (mg/L CaCO₃) | 576 |
| Hardness (mg/L CaCO₃) | 150 |
| Silica (mg/L) | 42.4 |
| Chlorides (mg/L) | 96.6 |
| Sulfates (mg/L) | 79 |
| Ca⁺² (mg/L) | 28 |
| Mg⁺² (mg/L) | 15.8 |
| Turbidity (NTU) | 0.63 |

After carrying out the tests of the electrodes i) to l) with a pH of 8, the corresponding adjustments of pH 6, 7 and 10 with their respective tests were made. It is emphasized, but not limiting the invention, that the adjustment to acidic values is carried out with 1M HCl, and to basic values with 1M NaOH. While operating conditions, that did not vary, were: 150 mL of sample, 0.25 Ampere of constant current, process time 10 minutes, mechanical stirring by magnetic stir bar and separation between electrodes of 15 mm.

Thus, according to FIG. 16, a comparative graph was obtained of the variation in kWh/kg energy consumption depending on the adjustment of the pH of the medium and the type of treatment to which the 2005 T3 aluminum electrodes have been subjected. According to the graph in FIG. 16, it was obtained that:

| | i) Not | | | |
|---|---|---|---|---|
| | subjected to | j) Cooled | k) Cooled | l) Cooled |
| Al 2005 T3 | heat treatment | in water | in air | in furnace |
| Without adjustment | 56.88 | 57.47 | 52.71 | 61.34 |
| (pH = 8.2) | | | | |
| Adjustment to | 41.09 | 40.80 | 40.80 | 41.99 |
| pH = 6 | | | | |
| Adjustment to | 44.67 | 40.80 | 43.48 | 40.50 |
| pH = 7 | | | | |
| Adjustment to | 53.00 | 54.20 | 55.68 | 53.90 |
| pH = 10 | | | | |

Based on the data obtained, it is concluded that with Al 2005 T3 slight reductions in kWh/kg energy consumption were obtained, particularly for electrode k) without pH adjustment, electrodes j) and k) adjusting pH to 6 and electrode k) with pH 7. However, a greater reduction in kWh/kg energy consumption could be observed by means of electrodes j) and l) with pH 7.

We claim:

1. An electrode for electrocoagulation, intended to be used in wastewater electrocoagulation plants, wherein the electrode comprises an electrode piece made of material selected from the group consisting of Aluminum, its alloys, Iron, and its alloys, said electrode piece being heat treated by heating said electrode piece for a period of time between 1 and 5 hours, at a temperature between 400° C. and 900° C., and subsequent cooling the electrode piece, having the material of said electrode piece a grain size measured by optical microscopy of between 0.087 mm and 0.530 mm.

2. The electrode of claim 1, wherein said material of the electrode piece is selected from the group of alloys consisting of Aluminum 1050, Aluminum 5086 H32 and Aluminum 2005 T3.

3. The electrode of claim 2, wherein said aluminum alloy is 5086 H32.

4. The electrode of claim 3, wherein said grain size is 0.087 mm.

5. A method for obtaining the electrode of claim 1, comprising:
Providing an electrode piece of a material selected from the group consisting of Aluminum, its alloys, Iron, and its alloys,
Heating the electrode piece for a period of time between 1 and 5 hours, at a temperature between 400° C. and 900° C., and
Cooling the electrode piece by means of at least one of the following cooling modes:
Rapid cooling in water,
Intermediate air cooling, and
Slow cooling by leaving the electrode inside the turned-off furnace until it reaches room temperature.

6. The method of claim 5, wherein said electrode piece is made of aluminum and is selected from the group of alloys consisting of Aluminum 1050, Aluminum 5086 H32 and Aluminum 2005 T3.

7. The method of claim 6, when said electrode piece is made of 5086 H32 Aluminum alloy, the heating period is 1 hour and the heating temperature is 550° C.

8. The method of claim 7, wherein said cooling mode is intermediate air cooling.

9. An electrocoagulation method using the electrode of claim 1, wherein the method comprises:
Having an electrocoagulation plant that includes a mass of wastewater to be purified and sacrificial electrodes in said mass of water, and
circulating electric current through said mass of water and the electrodes to produce the destabilization of the pollutants in the water that are in suspension, in emulsion or in solution, and
adjusting the pH of said mass of wastewater to a value between 6 and 10.

10. The method of claim 9, wherein said electrode is made of 5086 H32 aluminum alloy and the adjusted pH is 7.
